(19) United States
(12) Patent Application Publication
(10) Pub. No.: US 2021/0294553 A1
(43) Pub. Date: Sep. 23, 2021

(54) LIGHTBOARD SYSTEM

(71) Applicants: Christina Jackson, Williamsport, PA (US); Jack Tusman, Riegelsville, PA (US)

(72) Inventors: Christina Jackson, Williamsport, PA (US); Jack Tusman, Riegelsville, PA (US)

(73) Assignees: Commonwealth Charter Academy, Harrisburg, PA (US); CIMA Network Inc., Chalfont, PA (US)

(21) Appl. No.: 17/206,019

(22) Filed: Mar. 18, 2021

Related U.S. Application Data
(60) Provisional application No. 62/992,588, filed on Mar. 20, 2020.

(51) Int. Cl. G06F 3/14; H04N 7/18; H04N 5/262; B43L 1/00; G09B 5/02

(52) U.S. Cl. CPC G06F 3/14; H04N 7/18; G09B 5/02; B43L 1/004; H04N 5/2628

(57) ABSTRACT

A lightboard system providing the multiple advantages required by presenters to audiences. Wheels support and render mobile a base. Supported by the base, a frame defines an opening and includes pairs of vertical struts and corresponding vertical tubes, the tubes sliding along the struts in a telescoping movement to raise and lower the frame height. A clear screen is fixed within the opening; the height of the screen is adjusted as the frame telescopes. The screen has a front face displaying content from presenters and an opposing rear face, and induces paths for and scattering of light to highlight the content. A dimmable light source is embedded in the frame and illuminates the screen. Attached to a telescoping mount on the frame, a video camera is directed toward the rear face, streams or records the content to create images, and automatically flips the images for viewing by audiences.

### RELATED APPLICATION

This application claims the benefit of priority to U.S. Provisional Patent Application Ser. No. 62/992,588, filed on Mar. 20, 2020, the contents of which are incorporated in this application by reference.

### TECHNICAL FIELD

The present disclosure relates generally to teaching implements and, more particularly, to a lightboard system that provides the multiple advantages required by a modern presenter to an audience.

### BACKGROUND OF THE INVENTION

Lightboards are useful teaching tools that have become more prevalent in classrooms, study rooms, and tutorial centers around the world. A lightboard is created using a sheet of ultra-clear glass or Plexiglas® transparent acrylic in sheet form (available from Arkema of France) with edges illuminated by LED strip lights. The teacher (or presenter) writes on the sheet using a marker, as previously done with a chalkboard or whiteboard, while sitting or standing on one side of the sheet. Students and a camera are located on the opposite side of the sheet. The light bounces around inside the glass or Plexiglas® sheet until the light hits the writing on the sheet and then exits the sheet through the writing. This outcome highlights the writing against the backdrop.

After the camera records a lesson, the video file is transferred to editing software and reflected 180 degrees to turn the image to forward-facing for the viewer. Thus, the teacher is not required to write backwards. The writing becomes forward with a technological “flip” of the image. Lightboard videos can be produced quickly and with minimal post-production effort. Therefore, such videos are especially helpful when many videos must be made in relatively short time frames. Students like learning from lightboard videos because the experience is similar to the teacher presenting material at a chalkboard or whiteboard. Videos can be used for online learning, quick tutorials, problem solution explanations, or flipped lessons. A flipped lesson flips, or reverses, a traditional teaching lesson. Traditionally, the teacher talks about a topic at school and assigns homework that reinforces the material. In a flipped lesson, the instruction is delivered outside of class through videos, readings, or other independent learning activities. When students come to class, they already have the foundation knowledge, and class time can be used to fully engage in the content.

A lightboard can increase the engagement between the presenter and the student because the two parties can maintain eye contact throughout the video. In addition, students can see the presenter's facial expressions and observe body language, gaining the advantage of these physical cues. Lightboards can be used by a teacher in any subject area to convey any topic. Lightboards are especially well suited to teach concepts that require formulas, calculations, diagrams, and not too much text. Given their advantages and prevalence, lightboards have become available from a number of different sources.

Michael Peshkin, a Professor at Northwestern University, uses an “open source hardware” lightboard when teaching classes. The public is welcome to use the lightboard freely. Described at www.lightboard.info, his lightboard includes several features: optical reversal, PowerPoint overlay, and a live monitor with reflection cancellation.

Learning Glass Solutions of San Diego, California, offers commercially available lightboards under the name “Learning Glass.” See www.learning.glass; see also U.S. Design Patent No. D809,600. Learning Glass Solutions sells complete packages, including a board up to 3×5 feet (91.5×152 cm) in size, in a variety of configurations, including sound, video, and lighting.

Revolution Lightboards offers another commercially available turnkey lightboard, with options ranging from 34 inch (86 cm) diagonal tabletop models to 97 inch (246 cm) diagonal height adjustable models that can be used sitting or standing. See www.revolutionlightboards.com. Revolution Lightboards also offers do-it-yourself (DIY) lightboard kits to build a lightboard in 4×8 foot (122×244 cm) or 4×6 foot (122×183 cm) sizes with easy-to-assemble components. The steel frame, glass mounting hardware, edge lights, edge extrusions, and casters are available as kits.

A number of websites teach how to make do-it-yourself lightboards. See, for example, Steve Griffiths, “How to Make a Lightboard for Less Than $100 (Step-by-Step, With Illustrations)” (2017) (available at www.flippedlearning.org). Another example is titled “DIY Lightboard” and is available at www.instructables.com.

Despite the plethora of lightboards available, there is no single lightboard system that provides the multiple advantages required by a modern presenter. Therefore, a need exists for a lightboard system useful in higher education, K-12 schools, businesses, media companies, and other entities to facilitate communication and learning. An object of the present disclosure is to provide an improved lightboard system having multiple advantages. A related object is to move the lightboard system easily via integrated wheels. Another object is to include in the lightboard system a dimmable internal light source for both the screen and the presenter. An additional object is to include in the lightboard system a retractable power cord. Still other objects are to include a telescoping camera mount and a camera that automatically flips the image for real-time viewing by the audience. It is yet another object of the present disclosure to allow the height of the screen to be adjusted, up and down, to be compatible with the Americans with Disabilities Act of 1990 or ADA, to accommodate presenters of different heights, and to allow presenters to sit or stand.

### SUMMARY OF THE DISCLOSURE

To meet this and other needs and to achieve these and other objects, and in view of its purposes, the present disclosure reveals a lightboard system that provides the multiple advantages required by a presenter to an audience. The system has a base. Supported by the base, a frame defines an opening and includes a pair of vertical struts and a pair of corresponding vertical tubes, the tubes sliding along the struts in a telescoping movement to raise and lower the total height of the frame. A clear screen is fixed within the opening defined by the frame so that the height of the screen is adjusted as the frame telescopes. The screen has a front face configured to display content from the presenter and an opposing rear face, and induces paths for and scattering of light to highlight the content. A dimmable light source is embedded in the frame and illuminates the screen. A telescoping camera mount is attached to the frame. A video camera is attached to the camera mount and directed toward the rear face of the screen. The video camera streams or records the content displayed on the screen to create images and automatically flips the images for viewing by the audience.

In another embodiment, the lightboard system has a base. A plurality of wheels support the base and render the base mobile. Supported by the base, a frame defines an opening and includes a pair of vertical struts and a pair of corresponding vertical tubes, the tubes sliding along the struts in a telescoping movement to raise and lower the total height of the frame. A clear screen is fixed within the opening defined by the frame so that the height of the screen is adjusted as the frame telescopes. The screen has a front face configured to display content from the presenter and an opposing rear face, and induces paths for and scattering of light to highlight the content. A dimmable light source is embedded in the frame and illuminates the screen. At least one linear actuator facilitates the telescoping movement between the tubes and the struts; the at least one linear actuator is located inside one of the vertical tubes and raises and lowers the vertical tubes relative to the vertical struts, the stroke of the linear actuator defining the amount by which the height of the screen can be adjusted. A telescoping camera mount is attached to the frame. A video camera is attached to the camera mount and directed toward the rear face of the screen. The video camera streams or records the content displayed on the screen to create images and automatically flips the images for viewing by the audience. A power cord is configured to engage a power supply and deliver electricity from the power supply to the lightboard system. At least one of the base, the frame, and the camera mount are formed of aluminum and have a black matte finish.

In a more specific embodiment, the lightboard system has a base configured to form a compartment adapted to house and protect other components. A plurality of wheels support the base and render the base mobile. At least one power supply is housed in the base. Supported by the base, a frame defines an opening and includes a pair of vertical struts and a pair of corresponding vertical tubes, the tubes sliding along the struts in a telescoping movement to raise and lower the total height of the frame. A clear screen is fixed within the opening defined by the frame so that the height of the screen is adjusted as the frame telescopes. The screen has a front face configured to display content from the presenter and an opposing rear face, and induces paths for and scattering of light to highlight the content. A dimmable light source is embedded in the frame and illuminates the screen. At least one linear actuator facilitates the telescoping movement between the tubes and the struts; the at least one linear actuator is located inside one of the vertical tubes and raises and lowers the vertical tubes relative to the vertical struts, the stroke of the linear actuator defining the amount by which the height of the screen can be adjusted. A computer stand is mounted to the frame. A personal computer is supported on the computer stand and is adapted to allow the presenter to view the screen, move the location of the screen, and change the information that appears on the screen. A telescoping camera mount is attached to the frame. A video camera is attached to the camera mount and directed toward the rear face of the screen. The video camera streams or records the content displayed on the screen to create images and automatically flips the images for viewing by the audience. A power cord is configured to engage a power supply and deliver electricity from the power supply to the lightboard system. At least one of the base, the frame, and the camera mount are formed of aluminum and have a black matte finish.

It is to be understood that both the foregoing general description and the following detailed description are exemplary, but are not restrictive, of the disclosure.

### BRIEF DESCRIPTION OF THE DRAWING

The disclosure is best understood from the following detailed description when read in connection with the accompanying drawing. Included in the drawing are the following figures:

FIG. 1 is a front view of one embodiment of the lightboard system in accordance with the disclosure;

FIG. 2 is a top view of the embodiment of the lightboard system shown in FIG. 1;

FIG. 3 is a side view of the embodiment of the lightboard system shown in FIGS. 1 and 2;

FIG. 4 is a front view of one embodiment of the clear panel assembly of the lightboard system;

FIG. 5 is a top view of the clear panel assembly shown in FIG. 4;

FIG. 6 is a side view of the clear panel assembly shown in FIGS. 4 and 5;

FIG. 7 is a section view of a tray affixed to the frame of the lightboard system;

FIG. 8 is a perspective view of the lower portion of the frame and the base of the lightboard system;

FIG. 9 is a perspective view of the frame, the screen, the base, and certain of the electrical components of the lightboard system;

FIG. 10 is a front view of the lightboard system highlighting the linear actuators located inside the frame;

FIG. 11A is a front, perspective view of an alternative embodiment of the lightboard system configured for desktop placement;

FIG. 11B is a top view of the embodiment of the lightboard system shown in FIG. 11A;

FIG. 11C is a side view of the embodiment of the lightboard system shown in FIGS. 11A and 11B; and

FIG. 11D is a front view of the embodiment of the lightboard system shown in FIGS. 11A, 11B, and 11C.

### DETAILED DESCRIPTION OF THE DISCLSOURE

The features and benefits of the disclosed structures, components, and devices are illustrated and described by reference to exemplary embodiments. The disclosure also includes the drawing, in which like reference numbers refer to like elements throughout the various figures that comprise the drawing. This description of exemplary embodiments is intended to be read in connection with the accompanying drawing, which is to be considered part of the entire written description. Accordingly, the disclosure expressly should not be limited to such exemplary embodiments illustrating some possible non-limiting combinations of features that may exist alone or in other combinations of features.

In the description of embodiments, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top,” and “bottom” as well as derivatives of those terms (e.g., “horizontally,” “downwardly,” “upwardly,” etc.) should be construed to refer to the orientation as then described or as shown in the figure under discussion. These relative terms are for convenience of description only and do not require that the apparatus be construed or operated in a particular orientation. Terms such as “attached,” “affixed,” “connected,” “coupled,” “interconnected,” and similar terms refer to a relationship in which structures are secured or attached to one another either directly or indirectly through intervening structures, as well as both moveable or rigid attachments or relationships, unless expressly described otherwise.

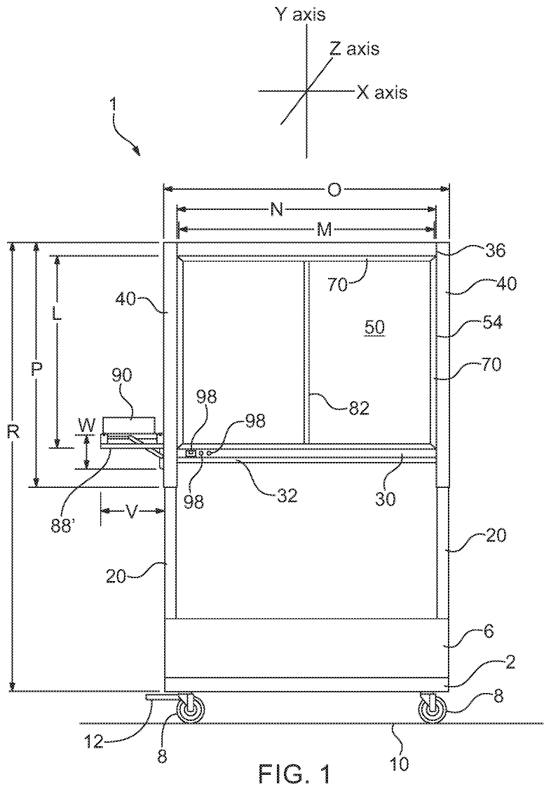

Referring now to the drawing, FIG. 1 is a front view of one embodiment of the lightboard system 1 in accordance with the disclosure. The lightboard system 1 is self-contained and is used to present information in real time, for video recording, or both. In any case, the lightboard system 1 allows the presenter 100 to maintain a visual presence with the audience, i.e., the presenter 100 can visually engage with the audience and communicate face-to-face as the presenter 100 uses the lightboard system 1 to present material. When using a traditional chalkboard or whiteboard to teach content or explain concepts, the back of the presenter 100 faces the audience. This traditional method does not allow for engagement by both the presenter 100 and the audience. The lightboard system 1 provides that advantage. The lightboard system 1 also allows other content such as videos or images to be overlaid to enhance the presentation.

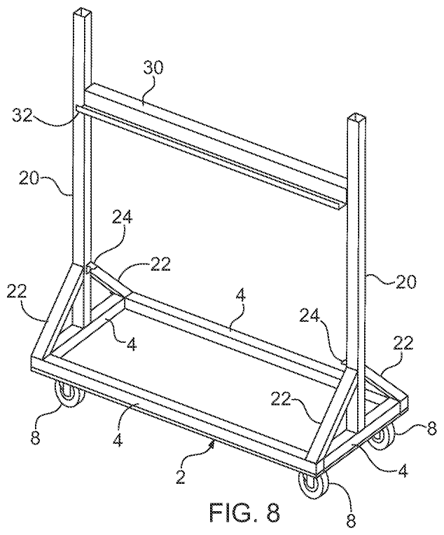

The lightboard system 1 has a solid, substantially flat pedestal or base plate 2. The base plate 2 is typically made of metal, with steel suitable and aluminum preferred, and has sufficient strength to support the storage of other items. Aluminum is preferred because it is relatively light and enables heat radiation. As illustrated in FIG. 8, the base plate 2 is a rectangular-shaped, single, solid piece. Alternatively, or in addition to the base plate 2, the base can be formed of four metal bars 4 (e.g., square bars) joined together to form the shape (e.g., rectangle) of the base while leaving a center opening in the base. The bars 4 can be made of 2×2 inch (5×5 cm) square aluminum tube having a thickness of 0.090 inches (0.23 cm). Both the base plate 2 and the bars 4 are included in the embodiment of the lightboard system 1 illustrated in the figures. Although the base can have a wide variety of shapes and sizes depending upon the application, in one example the base is a rectangle with sides of about 53 inches (135 cm) and 24.125 inches (61.3 cm). The base extends horizontally in the X-Z plane (with a thickness in the Y-direction) of the Cartesian coordinate system illustrated in FIG. 1.

A Cartesian coordinate system (X, Y, Z) is a coordinate system that specifies each point uniquely in three-dimensional space by three Cartesian numerical coordinates, which are the signed distances to the point from three, fixed, mutually perpendicular directed lines, measured in the same unit of length. Each reference line is called a coordinate axis or just an axis of the system, and the point where they meet is its origin, usually at ordered triplet (0, 0, 0). The coordinates can also be defined as the positions of the perpendicular projections of the point onto the three axes, expressed as signed distances from the origin.

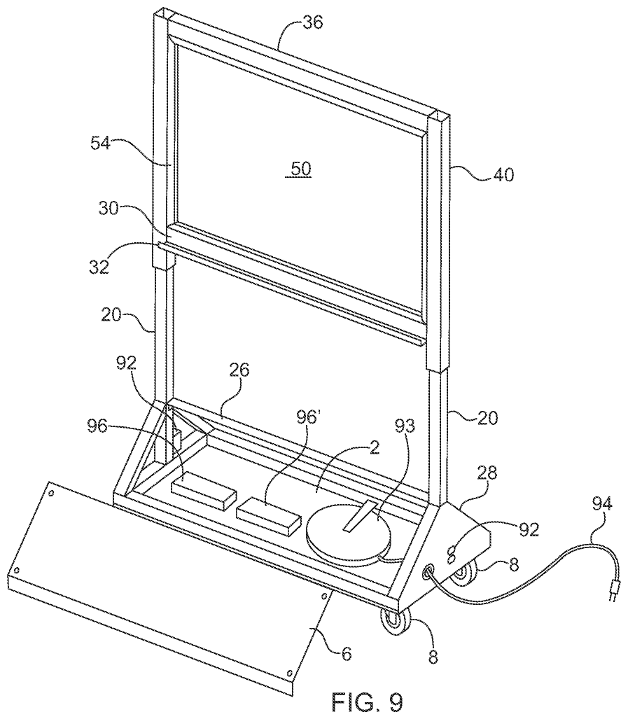

The base includes a cover 6 that extends from the base plate 2 upward to other components of the frame of the lightboard system 1. As shown in FIG. 9, the cover 6 may be angled and may be formed from two identical halves, one half of the cover 6 located on each side of the lightboard system 1. The cover 6 both is aesthetic and functions to protect components that are housed in the base. The cover 6 is preferably made of 0.063 inches (0.16 cm) thick aluminum sheet. Like many of the components of the lightboard system 1, the cover 6 is preferably given a black matte finish. The finish can be painted on the cover 6, although the finish is preferably powder coated on other components. A black matte finish provides a flat, non-reflective appearance and a sandy, rough texture. The color black absorbs all light on the visual spectrum, creating a void of light. As a result of absorbing all light wavelengths and avoiding light reflection, the black matte finish helps to prevent light interference from impacting the visual performance of the lightboard system 1.

A plurality of wheels 8 are affixed to the bottom surface of the base. Although four wheels 8 are illustrated in the figures, other numbers of wheels 8 could be used. The wheels 8 support the base and allow the lightboard system 1 to be maneuvered easily (specifically, rolled) by a user over a surface 10. Typically, the surface 10 is the floor of a building and is relatively flat.

The size and type of the wheels 8 can be predetermined to accommodate both a particular application (i.e., structural setting) in which the lightboard system 1 will be used and the size and weight of the base and other components supported on the base (i.e., wider and heavier components might require more wheels 8). By “predetermined” is meant determined beforehand, so that the predetermined characteristic (e.g., the size and type of the wheels 8) must be determined, i.e., chosen or at least known, in advance of some event (such as the manufacture of the particular embodiment of the lightboard system 1).

Relatively large (e.g., 1 inch or 2.5 cm diameter and 1 inch or 2.5 cm wide) caster wheels will roll over almost anything in an office or classroom, including rugs and carpets, without skidding. Caster wheels have ball bearing swivels for 360 degrees rotation, enhancing the maneuverability of the lightboard system 1. Therefore, relatively large caster wheels are suitable for the wheels 8 of the lightboard system 1. The specific set of wheels 8 affixed to the bottom surface of the base may include different wheels: two fixed wheels 8 may be affixed to the front of the base, for example, while two caster (swivel) wheels 8 are affixed to the rear of the base.

Suitable materials for construction of the wheels 8 are plastic; rubber; steel, aluminum, or other metals; tire tread; and combinations of such materials. A preferred material for the wheels 8 is polyurethane, which is a polymer composed of organic units joined by carbamate (urethane) links. Polyurethane is a true elastomer capable of tremendous impact resistance even at very high durometers. More important, polyurethane retains it elasticity and strength over the complete range of hardness.

One or more pedal stops 12, separate stops, or both pedal stops 12 and separate stops are provided on the lightboard system 1 to hold the lightboard system 1 in a stationary position, and prevent maneuvering the lightboard system 1, when desired. The pedal stop 12 is actuated when a user presses downward on the pedal stop 12, typically using a foot, and released when the user again presses downward on the pedal stop 12 to toggle the pedal stop 12 into its released position. As shown in FIG. 1, the pedal stops 12 are affixed directly to the wheels 8 such that, when actuated, the pedal stops 12 directly contact the wheels 8 and prevent the wheels 8 from rotating. Alternatively or in addition, one or more separate stops (akin to door stops) may be affixed to the base at a location or locations removed from the wheels 8 such that, when actuated, the one or more separate stops contact the surface 100 or other structure on which the wheels 8 otherwise roll and prevent the wheels 8 from rolling.

The base supports a vertical frame. The frame may be attached to the base, for example, by welding the frame to the base. Alternatively, the frame may be integral with the base. By “integral” is meant a single piece or a single unitary part that is complete by itself without additional pieces, i.e., the part is of one monolithic piece formed as a unit with another part. In the embodiment shown in FIGS. 1, 8, and 9, the frame includes two, identical, vertical struts 20 located on opposite ends of the base plate 2 (or, as illustrated, on opposite base bars 4). Two angled struts 22 give the frame additional support and extend at an angle from the base plate 2 (or, as illustrated, from the base bar 4) to a point on the vertical strut 20. Each vertical strut 20 is supported by two angled struts 22 (as shown). The vertical struts 20 and the angled struts 22 are formed of a strong metal. Steel is suitable but 2×2 inch (5×5 cm) square aluminum tube having a thickness of 0.090 inches (0.23 cm) is preferred.

An angle clip 24 is affixed (e.g., welded) to the inside of each vertical strut 20 proximate the point on the vertical strut 20 where the angled struts 22 engage the vertical strut 20. Suitable dimensions for the angle clip 24 are 1.5 inches (3.8 cm) by 1.5 inches (3.8 cm). The angle clips 24 support a horizontal top strip 26 (see FIG. 9) that extends between the two vertical struts 20 and supports the top ends of each half of the cover 6. The top strip 26 can be made of aluminum sheet having a thickness of 0.063 inches (0.16 cm).

In the embodiment shown in FIGS. 1 and 8, the frame includes two, identical, triangular-shaped portions, one portion located on each side of the frame and extending upward from the base in the “Y” direction. Each portion is defined by two of the angled struts 22 and the base plate 2 (and, as illustrated, by the base bar 4). A base side plate 28 is affixed to the frame over the triangular-shaped portion on each side of the frame and against the angled struts 22 and the base plate 2 (and, as illustrated, the base bar 4). The base side plate 28 both is aesthetic and functions to protect components that are housed in the base. The base side plate 28 is preferably made of 0.063 inches (0.16 cm) aluminum sheet and given a black matte finish. The finish can be painted on the base side plate 28. As shown in FIG. 3, the base side plate 28 may have a total height A of about 13.5 inches (34.3 cm), a depth B of about 24.125 inches (61.3 cm), an initial height C of about 2.5 inches (6.3 cm) suitable to match the combined heights of the 0.5 inches (1.3 cm) base plate 2 and the 2 inches (5 cm) base bar 4, and an angled distance D along the angled strut 22 of about 15.68 inches (40 cm).

In summary, the base of the lightboard system 1 is formed by the base plate 2 and/or base bars 4, portions of the vertical struts 20, the angled struts 22, the angle clips 24, the top strip 26, and the side plates 28. These components combine to form a base compartment that can safely house and protect other components, as illustrated in FIG. 9 and described below. The base of the lightboard system 1 supports the remainder of the vertically extending frame.

Included in the vertically extending frame is, in one embodiment, a stationary lower leg 30 (see FIG. 8) that extends horizontally and is fixed between (or is integral with) the two vertical struts 20. (In an alternative embodiment, as discussed below, the lower leg 30 may be part of the moveable upper frame.) The lower leg 30 has a U-shaped channel in its top surface to receive the screen 50 of the lightboard system 1 and defines the lowest height of the screen 50. The lower leg 30 can be made of 2.5×2.5 inch (6.35×6.35 cm) square aluminum tube having a thickness of 0.090 inches (0.23 cm). Like the vertical struts 20, the lower leg 30 is preferably given a powder coated black matte finish.

Powder coating is an advanced method of applying a decorative and protective finish to virtually any type of metal that can be used both by industry and consumers. The powder used in the process is a mixture of finely ground particles of pigment and resin, which is electrostatically sprayed onto the surface to be coated. The charged powder particles adhere to the electrically grounded surfaces until the powder is heated and fused into a smooth coating in a curing oven. The result is a uniform, durable, high quality and attractive finish. Powder coating is the fastest growing finishing technology in North America, representing over 10% of all industrial finishing applications.

A tray 32 can be affixed to any suitable location on the frame, including to the lower leg 30 (as illustrated), to store a wide variety of accessories. Alternatively, the tray 32 can be integrally formed with a frame component such as the lower leg 30. The tray 32 may be made of any suitable material, including plastic, and is preferably made of a bent sheet of 0.063 inches (0.16 cm) aluminum. The tray 32 is preferably given a powder coated black matte finish. In combination with the rear face of the lower leg 30, the tray 32 forms a U-shaped ledge along at least a portion of the horizontal length of the lower leg 30. As illustrated, the U-shaped ledge is formed along the entire horizontal length of the lower leg 30.

As shown in FIG. 3 and in the section view of FIG. 7, the tray 32 itself has a U-shape with a vertical front upright, a horizontal center, and a vertical rear upright. The center of the tray 32 extends horizontally along the entire bottom of the lower leg 30 (2.5 inches or 6.35 cm) and extends outward from the lower leg 30 by a distance E of about 2 inches (5 cm) so that the center of the tray 32 has a total length G of about 4.5 inches or 11.4 cm. The rear upright of the tray 32 extends vertically upward parallel to the rear face of the lower leg 30 by a distance F of about 1 inch (2.5 cm). The front upright of the tray 32 extends vertically upward along, and is in contact with, the entire front face of the lower leg 30 (2.5 inches or 6.35 cm). The tray 32 can be affixed to the lower leg 30 using any suitable mechanism, such as by welding or, as illustrated, with fasteners 34. Suitable fasteners are rivets, bolts, screws, pins, and the like.

The accessories stored in the tray 32 may include writing implements such as pens, pencils, and dry-erase markers; a remote control or computer mouse; and other conventional items. Dry-erase markers offer high quality writing performance and, as their name implies, can be dry-erased using an eraser or cloth. A damp, lint-free, microfiber or cotton cloth (which constitutes an additional accessory) can be used to erase or clean the screen 50 and render the screen 50 ready to accept new writing. Dry erase cleaner or isopropyl alcohol can facilitate the process of erasing. Such accessories as the markers, eraser, and cloth are commercially available from a plethora of sources including, for example, Egan Visual, Inc. of Canada (www.egan.com).

Dry-erase markers are useful accessories so that what the teacher or presenter writes on the screen 50 is best illuminated. The brightly colored markers feature bold neon shades that are highly visible, even at a distance. Each marker features a bullet tip designed to reduce squeaking noises while writing. The nontoxic ink is quick drying, which helps reduce smearing or smudging, and low odor. A typical commercial package contains five dry-erase markers in assorted colors.

As shown in FIG. 8, the vertical struts 20 of the frame have sections that extend vertically upward above the horizontal plane of the lower leg 30. Those sections of the vertical struts 20 engage corresponding vertical tubes 40 that also form part of the frame. Like the lower leg 30, the vertical tubes 40 can be made of 2.5×2.5 inch (6.35×6.35 cm) square aluminum tube having a thickness of 0.090 inches (0.23 cm). Like the vertical struts 20 and the lower leg 30, the vertical tubes 40 are preferably given a powder coated black matte finish.

Also included in the vertically extending frame is an upper leg 36 (see FIG. 1) that extends horizontally and is fixed between (or is integral with) the two vertical tubes 40. The upper leg 36 has a U-shaped channel in its bottom surface to receive the screen 50 of the lightboard system 1. Like the lower leg 30, the upper leg 36 can be made of 2.5×2.5 inch (6.35×6.35 cm) square aluminum tube having a thickness of 0.090 inches (0.23 cm) and is preferably given a powder coated black matte finish.

In the embodiment shown in FIG. 8, and as discussed above, the lower leg 30 is fixed to the vertical struts 20 and is stationary. In the alternative embodiment shown in FIGS. 1 and 9, the lower leg 30 is fixed to the vertical tubes 40 and, therefore, is part of the moveable upper frame.

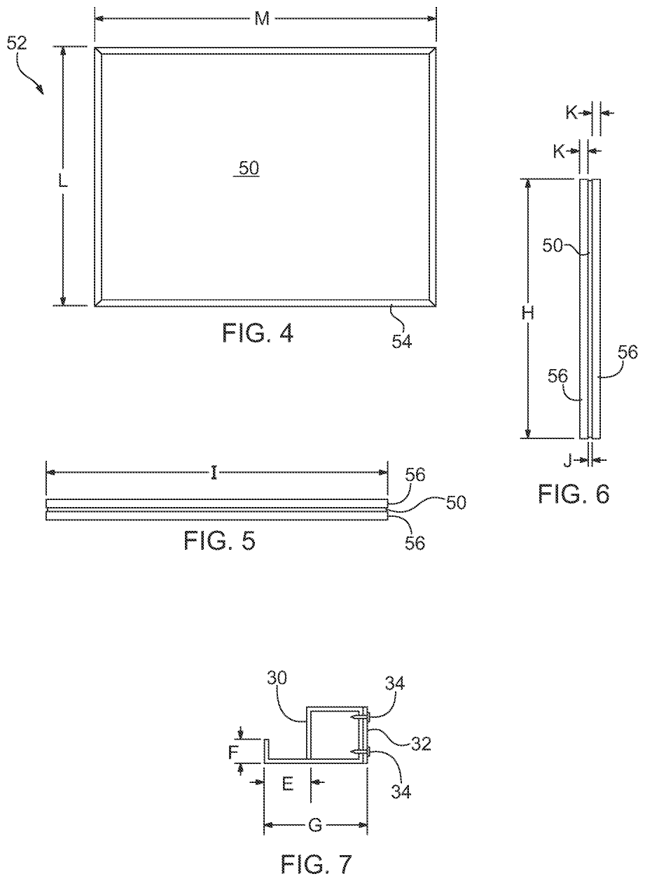

FIGS. 4, 5, and 6 are a front view, a top view, and a side view, respectively, of one embodiment of the clear panel assembly 52 of the lightboard system 1. The clear panel assembly 52 includes the screen 50 and forms a light emitting diode (LED) lightboard. The screen 50 itself forms a light guide panel for inducing paths for and scattering of light. Although other shapes are possible, including a square, the screen 50 is preferably shaped as a rectangle having, for example, a height H of 36 inches (3 feet or 91.4 cm) and a width I of 48 inches (4 feet or 122 cm).

The screen 50 is preferably made of clear acrylic having a thickness J of ⅜ inches (0.95 cm). Glass could also be used instead of acrylic. If glass is used, low-iron glass is preferred because such glass provides better light transmission. Standard or soda-lime glass has an inherent green tint that adds a color bias to videos created using the lightboard system 1. Whether acrylic or glass, the screen 50 could have an alternative thickness other than thickness J. For example, a thickness of 0.5 inches (1.25 cm) would add strength with the trade-off of added weight.

A rectangular border 54 is disposed around the screen 50. The border 54 is made of four edges 56 with each edge 56 made of two 1×1 inch (2.5×2.5 cm) square aluminum tubes having a thickness of 0.090 inches (0.23 cm). Thus, each tube that forms part of the edge 56 has a common height and width K of 1 inch (2.5 cm). The border 54 is preferably given a powder coated black matte finish.

FIG. 4 depicts the border 54 in position around the screen 50, forming the clear panel assembly 52. The clear panel assembly 52 has a height L of 36.375 inches (92.4 cm) and width M of 48.375 inches (122.9 cm). As shown in FIGS. 5 and 6, the screen 50 is held between two edges 56, forming a sandwich structure. Additional details about an alternative but suitable clear panel assembly 52 are provided in U.S. Pat. No. 8,235,575 titled “LED Light Board” and owned by Feelis Co., Ltd, of Korea.

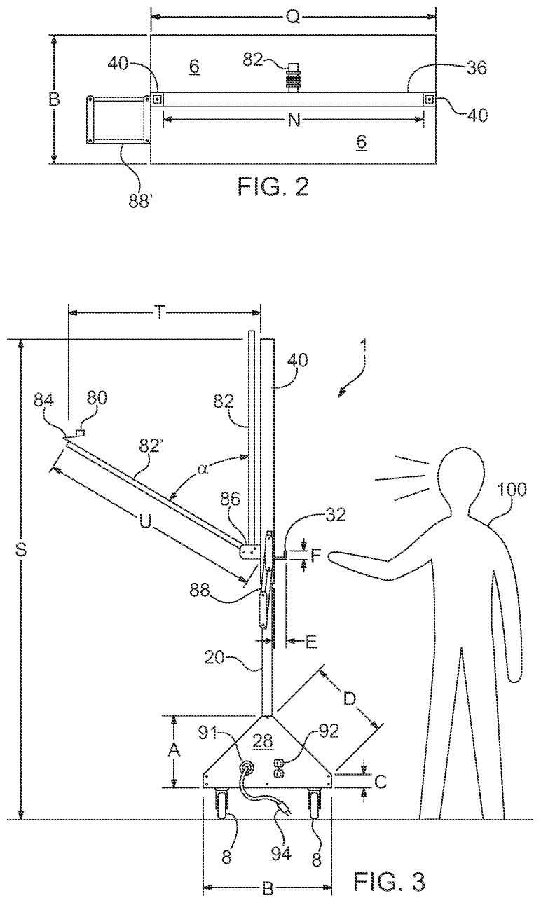

The clear panel assembly 52 is positioned and fixed within the opening in the frame formed by the lower leg 30, the upper leg 36, and the vertical tubes 40. See FIGS. 1 and 9. The lower leg 30 and the upper leg 36 each have a length N of about 48.5 inches (123.2 cm). Therefore, in combination with the width (2.5 inches or 6.35 cm) of the vertical tubes 40, the width O of the lightboard system 1 is about 53.5 inches (136 cm). The vertical tubes 40 each have a height P of about 46 inches (117 cm). As shown in FIG. 2, the base of the lightboard system 1 has a depth B of about 24.125 inches (61.3 cm) and a length Q of about 53 inches (135 cm).

The frame telescopes so that the height of the screen 50 can be adjusted by raising and lowering a portion of the frame and, therefore, the screen 50 fixed within that portion of the frame. The height can accommodate the heights of different presenters and allow the presenter to sit or stand. The height can be adjusted to an infinite number of positions within a specified vertical range (of, for example, 24 inches or 61 cm, 18 inches or 46 cm, or other suitable ranges). The Americans with Disabilities Act of 1990 or ADA is a law that prohibits discrimination based on disability. The ADA requires covered employers to provide reasonable accommodations to employees with disabilities, and imposes accessibility requirements on public accommodations. The adjustability of the lightboard system 1 helps employers meet the requirements of the ADA.

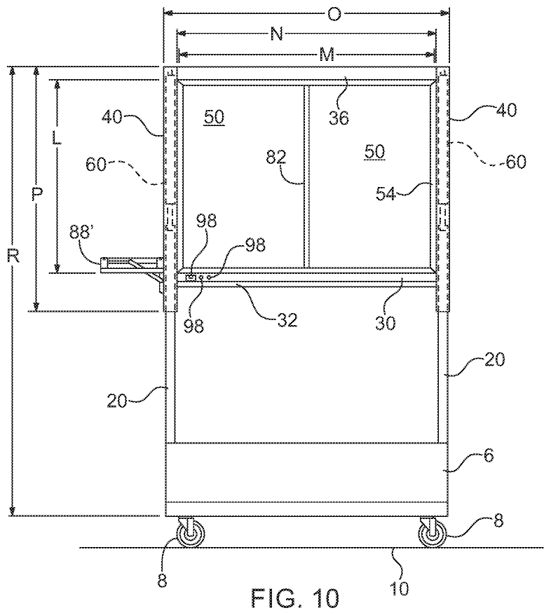

As shown in FIGS. 1, 9, and 10, the vertical struts 20 engage and fit within the corresponding vertical tubes 40 of the frame. The vertical struts 20 and the vertical tubes 40 are sized and shaped so that the vertical tubes 40 can slide up and down along the outside of the vertical struts 20 (i.e., the components are telescoping). Although the vertical tubes 40 might be manually raised and lowered (and then locked when a desired position is attained) with respect to the vertical struts 20, one or more linear actuators 60 is or are provided preferably to facilitate the telescoping movement. As shown in FIG. 10, a linear actuator 60 can be located inside each of the vertical tubes 40 and used to raise and lower the vertical tubes 40 relative to the vertical struts 20. The stroke of the linear actuator 60 defines the amount by which the height of the screen 50 can be adjusted.

Any one of a variety of conventional linear actuators 60 can be used in the lightboard system 1 to create motion in a straight line (i.e., up and down). For example, the linear actuator 60 may be a mechanical hydraulic or pneumatic cylinder that uses power inherently to produce linear motion. Mechanical actuators typically convert rotary motion of a control knob or handle into linear displacement via screws and/or gears to which the knob or handle is attached.

Hydraulic actuators or hydraulic cylinders typically involve a hollow cylinder having a piston inserted in it. An unbalanced pressure applied to the piston generates force that can move an external object. Because liquids are nearly incompressible, a hydraulic cylinder can provide controlled precise linear displacement of the piston. The displacement is only along the axis of the piston. Pneumatic actuators, or pneumatic cylinders, are similar to hydraulic actuators except that they use compressed gas to generate force instead of a liquid. They work similarly to a piston in which air is pumped inside a chamber and pushed out of the other side of the chamber.

Electro-mechanical actuators are similar to mechanical actuators except that the control knob or handle is replaced with an electric motor. Rotary motion of the motor is converted to linear displacement. Other conventional devices could also achieve the function of the linear actuator 60, as would be known by an artisan.

The height of the screen 50 is maximum when the linear actuator 60 is in its fully extended position (i.e., at full stroke). As shown in FIGS. 1 and 10, the total height R of the lightboard system 1 in the fully extended position from the top defined by the common tops of the upper leg 36 and the vertical tubes 40 to the lowest portion of the base is about 84.5 inches (215 cm). Including the wheels 8, and as shown in FIG. 3, the total height S of the lightboard system 1 is about 90.5 inches (230 cm) in the fully extended position.

An internal light source is included in the lightboard system 1 and illuminates the clear screen 50. The light source can be dimmed or brightened and is embedded in the frame that surrounds the screen 50. In one embodiment, the screen 50 is illuminated by an LED light strip or ribbon 70. The LED light strip 70 includes a plurality of LEDs that irradiate light. The intensity of the LEDs can be changed, which affects the amount of light irradiated and the color captured in video taken of the screen 50. The LEDs are arranged on a band-shaped printed circuit board (PCB) substrate at regular intervals. Electric wires (not shown) may provide electricity to the LED light strip 70 from a source of electricity (see below).

The length of the LED light strip 70 that is provided can accommodate different applications. The LED light strip 70 may be provided, for example, only in the U-shaped channel in the bottom surface of the upper leg 36. The U-shaped channel holds the LED light strip 70 in place; therefore, the LED light strip 70 is embedded in the U-channel of the upper leg 36 so that the top of the channel sits over both the LED light strip 70 and the screen 50. Neither the LED light strip 70 nor the U-shaped channel of the upper leg 36 are attached to the screen 50. This configuration makes it easier to replace any components that might fail.

Alternatively, as shown in FIG. 1, the LED light strip 70 may extend beyond the upper leg 36 and down the sides of the screen 50 along the perimeter of the screen 50. The LED light strip 70 is sized to wrap around the screen 50 without excess. The extent of the LED light strip 70 can be predetermined to accommodate different environments for the lightboard system 1. Regardless of its extent, the intensity of the LED light strip 70 can be adjusted. The LED light strip 70 illuminates the inside of the screen 50. Because the light source is placed behind writing on the external surface of the screen 50, the light source backlights the writing and creates a highlight that separates the writing from the background. This effect enhances the visibility of the writing. In some applications, the LED light strip 70 may be turned off so that the presenter is not visible in video taken of the screen 50.

Included in the lightboard system 1 is a video camera 80 that faces the screen 50. The video camera 80 is attached to a camera mount 82, 82′ using a V-shaped flange 84. The flange 84 is powder coated black. The camera mount 82, 82′ may be formed from a 1×1 inch (2.5×2.5 cm) square aluminum tube having a thickness of 0.090 inches (0.23 cm) that is powder coated black. As shown in FIG. 3, the camera mount 82 has a vertical, closed position when the video camera 80 is not in use and the camera mount 82′ has an angled, open position when the video camera 80 is in use.

The camera mount 82′ may form a preferred angle alpha (or α) of about 60 degrees from vertical when in its open position. Other angles are also suitable. When the camera mount 82′ is in its open position, in the embodiment shown in FIG. 3, the tip of the camera mount 82′ is a horizontal distance T of about 35.9 inches (91 cm) from the face of the vertical tubes 40 and an angled distance U of about 42.4 inches (108 cm) from the face of the vertical tubes 40 (which is proximate the face of the screen 50). The camera mount 82, 82′ may have only two, fixed positions (open and closed), or the camera mount 82, 82′ may be configured to be locked in any of the infinite positions including and between those two positions. The camera mount 82, 82′ is pivotably connected to the frame (e.g., to the lower leg 30) using a bracket 86 that is powder coated black. The camera mount 82, 82′ also may telescope to locate the video camera 80 in a wide variety of positions with respect to the screen 50.

The video camera 80 is used to stream or record content on the screen 50. The video camera 80 includes integrated reflection technology (mirroring software) that can flip the image created on the screen 50 by the presenter 180 degrees so that the viewer sees the same image from the opposite side. A suitable video camera 80 is the C922 Pro Stream HD Webcam available from Logitech Europe S.A. of Switzerland, with offices in Newark, Calif. The lightboard system 1 can use any audio device (e.g., a headset, Bluetooth, lapel mike, snowball mike, wired lavalier microphone, or the like) connected to the video camera 80 to project and record sound. If desired, a carriage can be attached to the frame to accommodate the audio device.

A foldable computer stand 88, 88′ is included in the lightboard system 1. Painted black, the computer stand 88, 88′ is mounted to the frame (e.g., to the side of one of the vertical tubes 40). Optionally, two computer stands 88, 88′ can be mounted to one each of the vertical tubes 40 or a single computer stand 88, 88′ can be releasably mounted to either or both of the vertical tubes 40 to accommodate right and left-handed users. The computer stand 88, 88′ is configured to support a conventional computer 90.

As shown in FIG. 1, the computer stand 88′ has a horizontal, open position when the computer 90 is in use. As shown in FIG. 3, the computer stand 88 has a vertical, closed position against the side of the vertical tube 40 when the computer 90 is not in use. The computer stand 88, 88′ is configured to fold between its open and closed positions like an accordion. When in its open position, the computer stand 88′ extends horizontally away from the vertical strut 20 a distance V of about 11.8 inches (30 cm) and has a vertical footprint W relative to the vertical tube 40 of about 6.3 inches (16 cm). Preferably, the computer stand 88, 88′ can have its height adjusted and can tilt 10-25 degrees to facilitate viewing by presenters having different characteristics (e.g., height, visual acuity, and the like).

The computer 90 is a machine that can be programmed to manipulate information. The principal characteristics of the computer 90 are that it responds to a specific set of instructions in a well-defined manner, can execute a prerecorded list of instructions (a program), and can quickly store and retrieve large amounts of data. The computer 90 can perform complex and repetitive procedures quickly, precisely, and reliably. Modern computers are electronic and digital. The actual machinery (wires, transistors, and circuits) is called hardware; the instructions and data are called software. All general-purpose computers require the following hardware components: a central processing unit (CPU) which is the heart of the computer and executes instructions organized in programs (“software”) that tell the computer what to do; memory (fast, expensive, short-term memory) that enables the computer to store, at least temporarily, data, programs, and intermediate results; a mass storage device (slower, cheaper, long-term memory) that allows the computer to permanently retain large amounts of data and programs between jobs (common mass storage devices include disk drives and tape drives); an input device, usually a keyboard and mouse, that is the conduit through which data and instructions enter the computer; and an output device such as a display screen, printer, or other device that lets the user see what the computer has accomplished. In addition to these components, many other components make it possible for the basic components to work together efficiently. For example, every computer requires a bus that transmits data from one part of the computer to another.

Computers can be generally classified by size and power, although there is considerable overlap in the classifications. The computer 90 may be any one of a personal computer (a small, single-user computer based on a microprocessor), a workstation (a powerful, single-user computer that is like a personal computer but has a more powerful microprocessor and, in general, a higher-quality monitor), a minicomputer (a multi-user computer capable of supporting up to hundreds of users simultaneously), a mainframe (a powerful multi-user computer capable of supporting many hundreds or thousands of users simultaneously), and a supercomputer (an extremely fast computer that can perform hundreds of millions of instructions per second).

Preferably, the computer 90 is a personal computer. Types of personal computers include a desktop, a laptop, a notebook, a subnotebook, a hybrid, a tablet, a palmtop, a personal digital assistant, or a smartphone. A presenter can interact with the computer 90 in many ways, including viewing the display screen, moving the location of the computer 90 and thereby the display screen, and changing the information that appears on the display screen. Such information might be, for example, learning videos, PowerPoint presentations, and other audio and visual information. The presenter can use the computer 90, for example, to confirm their physical location relative to the screen 50 and as a teleprompter to display content to the presenter.

Also included in the lightboard system 1 are various electrical components. Among the electrical components are the LED light strip 70 and an optional light dimmer as discussed above. In addition, the lightboard system 1 has one or more electric receptacles 92. Preferably, a receptacle 92 is provided on each end of the base and is accessible through the side plate 28. The receptacle 92 is a component of an electrical system that conducts electricity to any device plugged into it. Also referred to as an electrical outlet, the electric receptacle 92 is connected to a power source through wiring.

Alternative power sources are provided by the lightboard system 1. One source of power is a retractable power cord 94 that extends out of an opening 91 located in one of the side plates 28. Typically, only one retractable power cord 94 is necessary for the lightboard system 1. The retractable power cord 94 is configured to engage a conventional power supply such as an outlet in a building and to deliver electricity from the outlet to the lightboard system 1. The retractable power cord 94 resists oil and water. A suitable retractable power cord 94 has a length of 30 feet (914 cm), 16-gauge wire, and a rating of 10 amps at 120 volts.

The retractable power cord 94 can be extended and retracted using an automatic-wind cord reel 93. The reel 93 is preferably made of impact-resistant plastic and is durable. The reel 93 has a ratchet to hold the retractable power cord 94 in place at any length. A quick pull on the retractable power cord 94 releases the retractable power cord 94 and the spring-driven winding mechanism of the reel 93 retracts the retractable power cord 94. The reel 93 has a resettable circuit breaker to prevent overload damage. As illustrated in FIG. 9, the reel 93 can be mounted to the base plate 2 with a quick-release mounting bracket (not shown).

Additional sources of power can be provided by the lightboard system 1. As illustrated in FIG. 9, the lightboard system 1 has a first power supply 96 and a second power supply 96′. The first power supply 96 may be a 12 volt battery and the second power supply 96′ may be a 24 volt battery. The first power supply 96 and the second power supply 96′ may be housed in the base compartment. By including these two internal power sources, the lightboard system 1 can be used without access to any external power supply.

Among the various electrical components provided by the lightboard system 1 are a series of electrical interfaces 98. The electrical interfaces 98 may be located on the frame of the lightboard system 1, such as on the lower leg 30, allowing easy access by the presenter. The electrical interfaces 98 include, for example, switches, on/off touch lighting controls, and a 30 amp rocker switch. The electrical interfaces 98 enable the presenter to control the electrical components of the lightboard system 1.

The lightboard system 1 may include additional components beyond those components described above. For example, a frosted glass attachment can be attached directly to the front of the screen 50. The opacity of the attachment can be predetermined; 50% opacity is suitable for many applications. Spring-loaded clips are suitable as an attachment mechanism, holding the attachment flush against the screen 50. A projector placed in front of the screen 50 displays the desired image onto the attachment. The projector must be placed in the “rear display” mode so that the image appears in its correct orientation to the presenter. (When the image is subsequently flipped again for the viewer, the image will appear in its correct orientation.)

A controller is a hardware device or a software program that manages or directs the flow of data (i.e., facilitates communication, perhaps through a transceiver) between two components. The computer 90 of the lightboard system 1 can include a controller (or the lightboard system 1 could include a separate controller). The controller provides the ability to obtain data from, for example, the frame, the wheels 8, the pedal stop 12, the screen 50, the linear actuator 60, the LED light strip 70, the video camera 80, the camera mount 82, 82′, the computer stand 88, 88′, and the electrical components, and to use that data to control the other components of the lightboard system 1. The controller has programmed in it, in a manner well-known to those skilled in the art, a preset control program or routine to assure efficiently the operation of the various components of the lightboard system 1. More specifically, the controller can, for example, raise or lower the screen 50, dim or brighten the LED light strip 70, cause the wheels 8 to move, activate the pedal stop 12, and position the video camera 80. A hand-held joystick (not shown) could interact through the controller to fully control and steer the lightboard system 1 to a room or to a specific location in a room without human physical interaction. The controller helps to assure a robust and reproducible automated operation of the lightboard system 1.

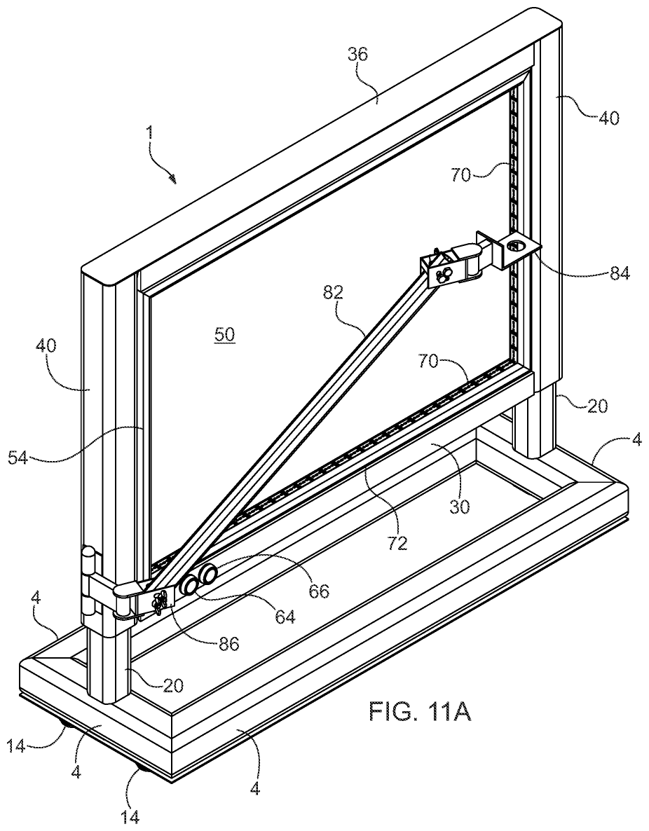

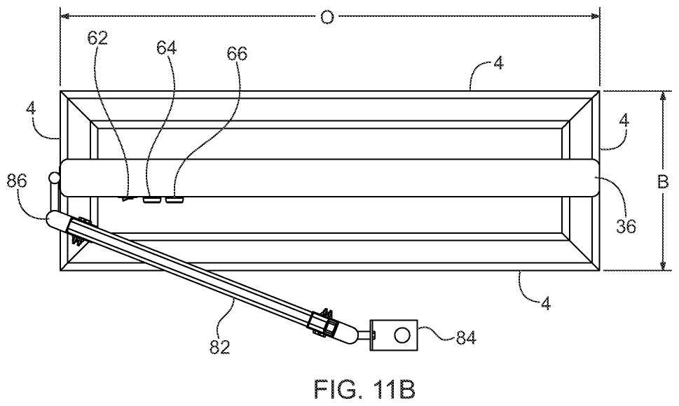

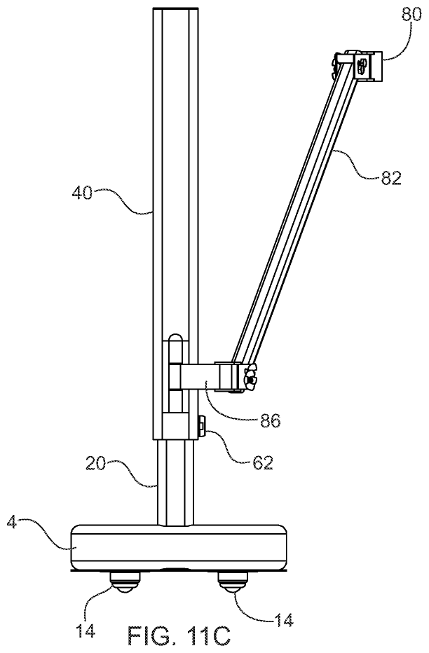

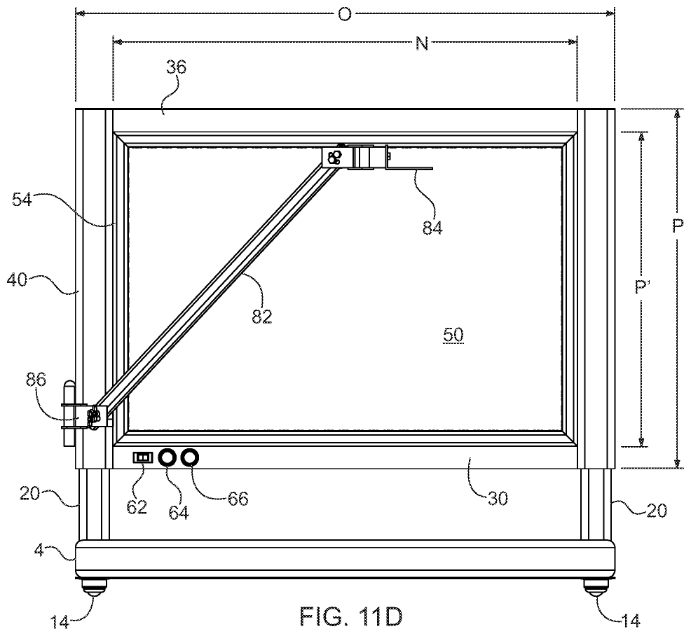

FIGS. 11A, 11B, 11C, and 11D illustrate an alternative embodiment of the lightboard system 1 configured for desktop placement. FIG. 11A is a front, perspective view; FIG. 11B is a top view; FIG. 11C is a side view; and FIG. 11D is a front view of this embodiment. Although the surface 10 on which this embodiment is placed could be the floor of a building, the surface 10 could also be a desktop, a podium, or other relatively flat support surface.

The lightboard system 1 has a solid, substantially flat pedestal or base plate 2. The base plate 2 is typically made of metal, with steel suitable and aluminum preferred, and has sufficient strength to support the storage of other items. Aluminum is preferred because it is relatively light and enables heat radiation. Alternatively, as illustrated in FIG. 11A, or in addition to the base plate 2, the base can be formed of four metal bars 4 (e.g., square bars) joined together to form the shape (e.g., rectangle) of the base while leaving a center opening in the base. The bars 4 can be made of 2×2 inch (5×5 cm) square aluminum tube having a thickness of 0.090 inches (0.23 cm).

Unlike the embodiments described above, the embodiment of the lightboard system 1 illustrated in FIG. 11A does not have wheels 8 or pedal stops 12 (although it could). Rather, this embodiment has a plurality of non-marking ball casters 14 located on the bottom of the base. Any suitable number of casters 14 located to support the base and move the lightboard system 1 could be used, as an artisan would know, but four casters 14 are illustrated. One or more separate stops that contact the surface 100 could be used instead of the casters 14 to support the base and prevent the lightboard system from moving.

The base supports a vertical frame. In the embodiment shown in FIG. 11A, the frame includes two, identical, vertical struts 20 located on opposite base bars 4. The vertical struts 20 are formed of a strong metal. Steel is suitable but 2×2 inch (5×5 cm) square aluminum tube having a thickness of 0.090 inches (0.23 cm) is preferred. The vertical struts 20 engage corresponding vertical tubes 40 that also form part of the frame. The vertical tubes 40 can be made of 2.5×2.5 inch (6.35×6.35 cm) square aluminum tube having a thickness of 0.090 inches (0.23 cm).

Also included in the vertically extending frame are the lower leg 30 and the upper leg 36, both of which extend horizontally and are fixed between (or are integral with) the two vertical tubes 40. The lower leg 30 has a U-shaped channel in its top surface and the upper leg 36 has a U-shaped channel in its bottom surface to receive the screen 50 of the lightboard system 1. The lower leg 30 and the upper leg 36 can be made of 2.5×2.5 inch (6.35×6.35 cm) square aluminum tube having a thickness of 0.090 inches (0.23 cm). As for the embodiments described above, many of the components of the lightboard system 1 illustrated in FIG. 11A are preferably given a powder coated black matte finish.

The tray 32 illustrated in FIG. 7 could be affixed to any suitable location on the frame to store a wide variety of accessories. The tray 32 is typically unnecessary for the embodiment of the lightboard system 1 illustrated in FIG. 11A, however, because other structures proximate the lightboard system 1 (e.g., the top of the desk or podium, drawers, and the like) are often available to store accessories. Similarly, the computer stand 88, 88′ illustrated in FIGS. 1, 2, and 3 could be affixed to any suitable location on the frame to support the computer 90. The computer stand 88, 88′ is typically unnecessary for the embodiment of the lightboard system 1 illustrated in FIG. 11A, however, because other structures proximate the lightboard system 1 (e.g., the top of the desk or podium, drawers, a computer stand, and the like) are often available to support the computer 90.

The same clear panel assembly 52 illustrated in FIGS. 4, 5, and 6 is included in the embodiment of the lightboard system 1 illustrated in FIG. 11A. The clear panel assembly 52 includes the screen 50 and forms a light emitting diode (LED) lightboard. The rectangular border 54 is disposed around the screen 50.

As shown in FIG. 11B, the width O of the lightboard system 1 is about 40 inches (102 cm) and its depth B is about 12 inches (30.5 cm). As shown in FIG. 11D, the vertical tubes 40 each have a height P of about 28 inches (71 cm) so that the height P′ defined between the lower leg 30 and the upper leg 36 is about 26 inches (66 cm). The lower leg 30 and the upper leg 36 each have a length N of about 39 inches (99 cm).

The frame telescopes so that the height of the screen 50 can be adjusted by raising and lowering a portion of the frame and, therefore, the screen 50 fixed within that portion of the frame. As shown in FIGS. 11A, 11C, and 11D, the vertical struts 20 engage and fit within the corresponding vertical tubes 40 of the frame. The vertical struts 20 and the vertical tubes 40 are sized and shaped so that the vertical tubes 40 can slide up and down along the outside of the vertical struts 20 (i.e., the components are telescoping).

An internal light source is included in the lightboard system 1 and illuminates the clear screen 50. The light source can be dimmed or brightened and is embedded in the frame that surrounds the screen 50. In the embodiment shown in FIG. 11A, the screen 50 is illuminated by the white dimmable LED strip or ribbon 70. In addition, as shown in FIG. 11A, a second LED strip or ribbon 72 can optionally be provided on the presenter-side of the lightboard system 1. The second LED strip or ribbon 72 may be located along the top edge of the lower leg 30.

Included in the lightboard system 1 is the video camera 80 that faces the screen 50. The video camera 80 is attached to the camera mount 82 using a U-shaped flange 84. The flange 84 is powder coated black. The camera mount 82 may be formed from a 1×1 inch (2.5×2.5 cm) square aluminum tube having a thickness of 0.090 inches (0.23 cm) that is powder coated black. The camera mount 82 is pivotably connected to the frame (e.g., to a lower portion of one of the vertical tubes 40) using a bracket 86 that is powder coated black. The bracket 86 allows full articulation of the camera mount 82; therefore, the camera mount 82 cans swing in a plane perpendicular to the screen 50 and rotate both up and down.

Included in the embodiment of the lightboard system 1 illustrated in FIG. 11A are various electrical components such as a series of electrical interfaces 98. The electrical interfaces 98 may be located on the frame of the lightboard system 1, such as on the lower leg 30, allowing easy access by the presenter. The electrical interfaces 98 include, for example, an on/off power switch 62, a control 64 for the LED light strip 70, and a second control 66 for the second LED light strip 72. The electrical interfaces 98 enable the presenter to control the electrical components of the lightboard system 1.

The lightboard system 1 as described in several embodiments above, with its multiple advantages, has many applications. Among other applications, the lightboard system 1 can be used to make educational and business presentations, sports playbooks, story boards, and engineering or architectural drawings. The lightboard system 1 can facilitate content marketing, live visual conferencing, training, and video production.

In use, the environment surrounding the lightboard system 1 should be as free of natural light as possible. Blinds if present in a room should be lowered to block sunlight; artificial lights in the room should be turned off to minimize glare and reflection. Preferably, the lightboard system 1 should be positioned in front of a green screen or a plain black backdrop. The presenter should not write on the screen 50 directly in front of the presenter; rather, the presenter should write in the space on the screen 50 beside them so that the writing can be seen on the screen 50 and video.

Although illustrated and described above with reference to certain specific embodiments and examples, the present disclosure is nevertheless not intended to be limited to the details shown. Rather, various modifications may be made in the details within the scope and range of equivalents of the claims and without departing from the spirit of the disclosure.

What is claimed:

1. A lightboard system providing the multiple advantages required by a presenter to an audience, the system comprising:
a base;
a frame supported by the base, defining an opening, and including a pair of vertical struts and a pair of corresponding vertical tubes, the tubes sliding along the struts in a telescoping movement to raise and lower the total height of the frame;
a clear screen fixed within the opening defined by the frame so that the height of the screen is adjusted as the frame telescopes, the screen having a front face configured to display content from the presenter, having an opposing rear face, and inducing paths for and scattering of light to highlight the content;
a dimmable light source embedded in the frame and illuminating the screen;
a telescoping camera mount attached to the frame; and
a video camera attached to the camera mount and directed toward the rear face of the screen, the video camera streaming or recording the content displayed on the screen to create images and automatically flipping the images for viewing by the audience.

2. The lightboard system according to claim 1 further comprising a tray affixed to the frame, the tray configured to store accessories.

3. The lightboard system according to claim 1 further comprising a computer stand mounted to the frame and configured to support a computer.

4. The lightboard system according to claim 3 further comprising a computer adapted to assist the presenter.

5. The lightboard system according to claim 4 wherein the computer is a personal computer adapted to allow the presenter to view the screen, move the location of the screen, and change the information that appears on the screen.

6. The lightboard system according to claim 1 further comprising a stop configured to hold the lightboard system in a stationary position.

7. The lightboard system according to claim 1 further comprising a border disposed around the screen.

8. The lightboard system according to claim 1 further comprising at least one linear actuator facilitating the telescoping movement between the tubes and the struts.

9. The lightboard system according to claim 8 wherein the at least one linear actuator is located inside one of the vertical tubes and raises and lowers the vertical tubes relative to the vertical struts, the stroke of the at least one linear actuator defining the amount by which the height of the screen can be adjusted.

10. The lightboard system according to claim 1 further comprising at least one electric receptacle provided on the base and connected to a power source through wiring.

11. The lightboard system according to claim 1 further comprising at least one power supply housed in the base.

12. The lightboard system according to claim 1 wherein at least one of the base, the frame, and the camera mount are formed of aluminum and have a black matte finish.

13. The lightboard system according to claim 1 further comprising a plurality of wheels supporting the base and rendering the base mobile.

14. The lightboard system according to claim 1 further comprising a power cord configured to engage a power supply and deliver electricity from the power supply to the lightboard system.

15. The lightboard system according to claim 1 wherein the base is configured to form a compartment adapted to house and protect other components.

16. A lightboard system providing the multiple advantages required by a presenter to an audience, the system comprising:
a base;
a plurality of wheels supporting the base and rendering the base mobile;
a frame supported by the base, defining an opening, and including a pair of vertical struts and a pair of corresponding vertical tubes, the tubes sliding along the struts in a telescoping movement to raise and lower the total height of the frame;
a clear screen fixed within the opening defined by the frame so that the height of the screen is adjusted as the frame telescopes, the screen having a front face configured to display content from the presenter, having an opposing rear face, and inducing paths for and scattering of light to highlight the content;
a dimmable light source embedded in the frame and illuminating the screen;
at least one linear actuator facilitating the telescoping movement between the tubes and the struts, wherein the at least one linear actuator is located inside one of the vertical tubes and raises and lowers the vertical tubes relative to the vertical struts, the stroke of the linear actuator defining the amount by which the height of the screen can be adjusted;
a telescoping camera mount attached to the frame, wherein at least one of the base, the frame, and the camera mount are formed of aluminum and have a black matte finish;
a video camera attached to the camera mount and directed toward the rear face of the screen, the video camera streaming or recording the content displayed on the screen to create images and automatically flipping the images for viewing by the audience; and
a power cord configured to engage a power supply and deliver electricity from the power supply to the lightboard system.

17. The lightboard system according to claim 16 further comprising a computer stand mounted to the frame and a personal computer supported on the computer stand, the computer adapted to allow the presenter to view the screen, move the location of the screen, and change the information that appears on the screen.

18. The lightboard system according to claim 16 further comprising at least one power supply housed in the base.

19. The lightboard system according to claim 16 wherein the base is configured to form a compartment adapted to house and protect other components.

20. A lightboard system providing the multiple advantages required by a presenter to an audience, the system comprising:
a base configured to form a compartment adapted to house and protect other components;
at least one power supply housed in the base;
a plurality of wheels supporting the base and rendering the base mobile;
a frame supported by the base, defining an opening, and including a pair of vertical struts and a pair of corresponding vertical tubes, the tubes sliding along the struts in a telescoping movement to raise and lower the total height of the frame;
a clear screen fixed within the opening defined by the frame so that the height of the screen is adjusted as the frame telescopes, the screen having a front face configured to display content from the presenter, having an opposing rear face, and inducing paths for and scattering of light to highlight the content;
a dimmable light source embedded in the frame and illuminating the screen;
at least one linear actuator facilitating the telescoping movement between the tubes and the struts, wherein the at least one linear actuator is located inside one of the vertical tubes and raises and lowers the vertical tubes relative to the vertical struts, the stroke of the linear actuator defining the amount by which the height of the screen can be adjusted;
a computer stand mounted to the frame;
a personal computer supported on the computer stand, the computer adapted to allow the presenter to view the screen, move the location of the screen, and change the information that appears on the screen;
a telescoping camera mount attached to the frame, wherein at least one of the base, the frame, and the camera mount are formed of aluminum and have a black matte finish;
a video camera attached to the camera mount and directed toward the rear face of the screen, the video camera streaming or recording the content displayed on the screen to create images and automatically flipping the images for viewing by the audience; and
a power cord configured to engage a power supply and deliver electricity from the power supply to the lightboard system.
